(19) United States
(12) Patent Application Publication
(10) Pub. No.: US 2015/0118447 A1
(43) Pub. Date: Apr. 30, 2015

(54) COMPONENT ASSEMBLY MANUFACTURING METHOD, POSITIONING APPARATUS, AND COMPONENT ASSEMBLY

(71) Applicant: FUJITSU LIMITED, Kawasaki-shi (JP)

(72) Inventors: Hideyuki Fujikawa, Kawasaki (JP); Naoki ISHIKAWA, Nagano (JP); Yutaka NODA, Kawasaki (JP)

(21) Appl. No.: 14/504,623

(22) Filed: Oct. 2, 2014

(30) Foreign Application Priority Data
Oct. 24, 2013 (JP) 2013-221235

(51) Int. Cl. B32B 37/10; B32B 7/12; B32B 37/00; B32B 37/12; B32B 37/18

(52) U.S. Cl. CPC B32B 37/10; B32B 37/1284; B32B 37/18; B32B 37/0046; B32B 7/12; B32B 2037/1081
USPC 428/172; 156/275.7; 156/379.8; 428/457; 428/201

(57) ABSTRACT

A component assembly manufacturing method includes positioning a first component to a jig, applying an adhesive to at least one of an adhesion surface of the first component and an adhesion surface of a second component, positioning the second component to the first component by a magnetic force that acts between the second component and the jig, in a state in which the adhesive in an uncured state is arranged between the adhesion surface of the first component and the adhesion surface of the second component, and fixing the first component and the second component by the adhesive.

### CROSS-REFERENCE TO RELATED APPLICATION

This application is based upon and claims the benefit of priority of the prior Japanese Patent Application No. 2013-221235, filed on Oct. 24, 2013, the entire contents of which are incorporated herein by reference.

### FIELD

The embodiment discussed herein is related to a component assembly manufacturing method, a positioning apparatus, and a component assembly.

### BACKGROUND

In conventionally known hybrid IC manufacturing methods, when a predetermined mounting component is to be attached on a substrate, the mounting component that is to be attached on the substrate is attracted and held by a magnet in a predetermined position on the substrate. Such technologies are, for example, disclosed in Japanese Laid-open Patent Publication No. 11-121917.

### SUMMARY

According to an aspect of the invention, a component assembly manufacturing method includes positioning a first component to a jig, applying an adhesive to at least one of an adhesion surface of the first component and an adhesion surface of a second component, positioning the second component to the first component by a magnetic force that acts between the second component and the jig, in a state in which the adhesive in an uncured state is arranged between the adhesion surface of the first component and the adhesion surface of the second component, and fixing the first component and the second component by the adhesive.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view of a manufacturing apparatus;

FIG. 2 is a perspective view depicting a state in which a first component is positioned in a first jig in the manufacturing apparatus of FIG. 1;

FIG. 3 is a perspective view depicting a state in which a second component is positioned in the fixing position of the first component in the manufacturing apparatus of FIG. 1;

FIG. 4 is a side cross-sectional view of the manufacturing apparatus;

FIG. 5 is a bottom view of the second component;

FIG. 6 is a plan view in which the fixing position portion of the first compartment is enlarged;

FIGS. 7A and 7B are drawings for illustrating control regarding the strength and the polarity of a magnetic force;

FIG. 8 is a side cross-sectional view according to a first modified example;

FIG. 9 is a side cross-sectional view according to a second modified example;

FIG. 10 is a side cross-sectional view according to a third modified example;

FIG. 11 is a side cross-sectional view according to the third modified example;

FIG. 12 is a side cross-sectional view according to a fourth modified example; and

FIG. 13 is a side cross-sectional view according to a fifth modified example.

### DESCRIPTION OF EMBODIMENT

The technology disclosed in the present application provides a component assembly manufacturing method with which a second component is able to be positioned with a high degree of precision with respect to a first component.

An embodiment of the technology disclosed in the present application is described hereafter.

(Manufacturing Apparatus 10)

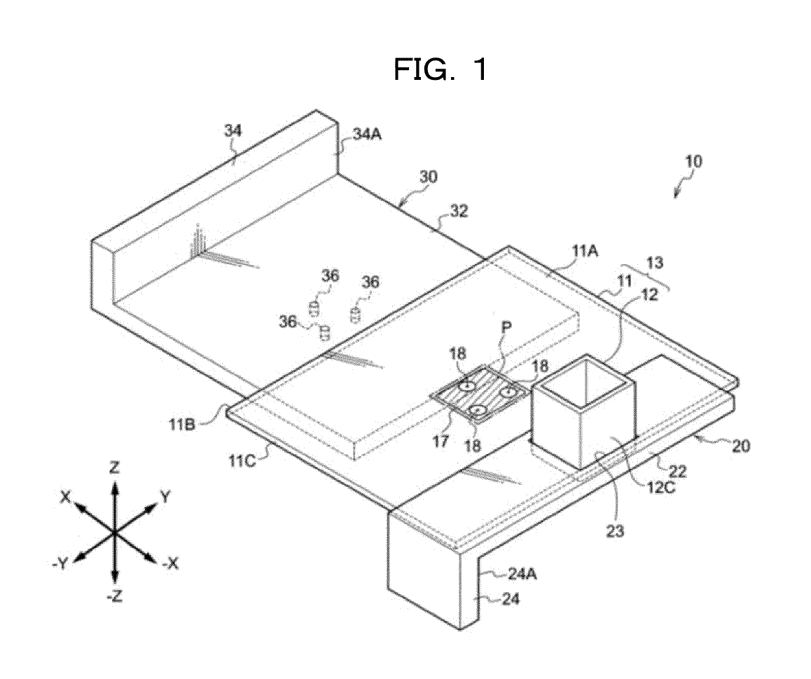

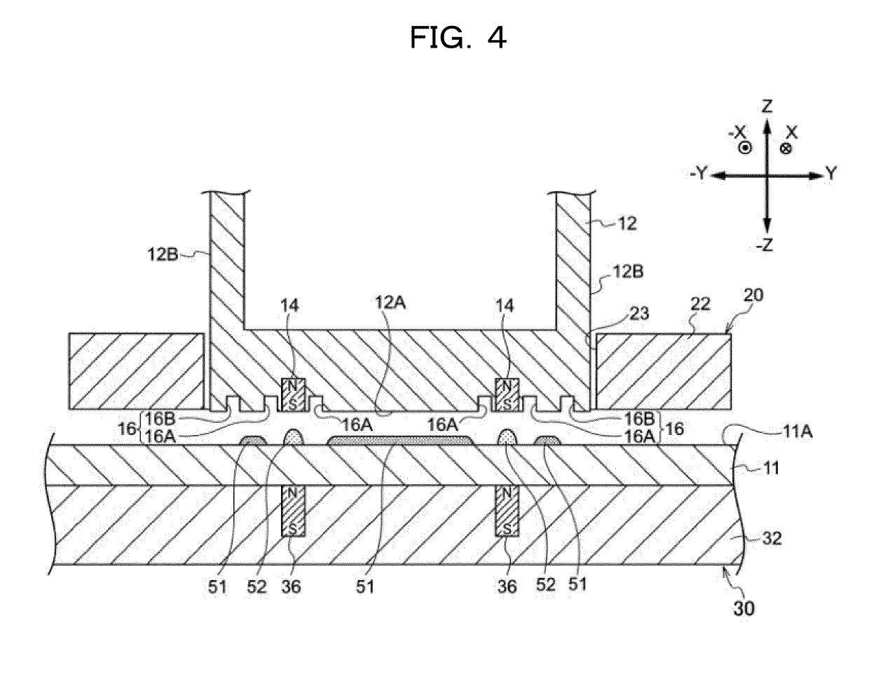

A manufacturing apparatus 10 (an example of a positioning apparatus) according to the present embodiment will now be described. FIG. 1 to FIG. 3 are perspective views of the manufacturing apparatus 10 according to the present embodiment. FIG. 4 is a side cross-sectional view of the manufacturing apparatus 10 according to the present embodiment. It ought to be noted that the X direction, −X direction, Y direction, −Y direction, Z direction, and −Z direction mentioned hereafter are the arrow directions depicted in the drawings.

As depicted in FIG. 1 to FIG. 3, the manufacturing apparatus 10 is an apparatus that manufactures a component assembly 13 obtained by fixing a second component 12 in a predetermined fixing position P in a first component 11. In this manufacturing apparatus 10, the second component 12 is positioned in a predetermined fixing position P in the first component 11, and the second component 12 is then fixed in that fixing position P using adhesives. Specifically, the manufacturing apparatus 10 has a first jig 30 and a second jig 20. The specific structures of this first jig 30 and the second jig 20 are described hereafter.

(Adhesives)

As adhesives for fixing the first component 11 and the second component 12, for example, two types of adhesives having different curing times are used. In other words, as depicted in FIG. 4, a first adhesive 51 and a second adhesive 52 having a shorter curing time than the first adhesive 51 are used as the adhesives. For example, an instantaneous adhesive that cures in a short period of time is used as the second adhesive 52. Instantaneous adhesives have the property of curing by reacting with moisture that is present in the air and the adhesion surfaces. Consequently, curing of the second adhesive 52 is induced when, for example, the surface area that comes into contact with moisture increases due to being formed into a thin layer and so forth. This second adhesive 52 is used for temporary fixing with which the first component 11 and the second component 12 are temporarily fixed.

Although the first adhesive 51 has a longer curing time than the second adhesive 52, the first adhesive 51 has the property of being stronger than the second adhesive 52 with respect to shear force and impact. An adhesive that cures due to stimuli such as ultraviolet rays, pressure, and heat is used as the first adhesive 51. This first adhesive 51 is used for permanent fixing with which the first component 11 and the second component 12 are permanently fixed. It ought to be noted that the first adhesive 51 and the second adhesive 52 are viscous when uncured.

(First Component 11 and Second Component 12)

As depicted in FIG. 1, for example, a component having a rectangular sheet shape is used as the first component 11. In addition, for example, a transparent sheet member on which a coating has been applied for design purposes to the front surface at the fixing position P or the rear surface thereof is used as the first component 11. As depicted in FIG. 4, in the first component 11, the front surface at the Z direction side is an adhesion surface 11A for the second component 12.

As depicted in FIG. 1, for example, a cuboidal box-shaped component that is open in the Z direction (upward) is used as the second component 12. As depicted in FIG. 4, in the second component 12, the front surface at the −Z direction side is an adhesion surface 12A for the first component 11. Consequently, the adhesion direction of the second component 12 with respect to the first component 11 is the −Z direction.

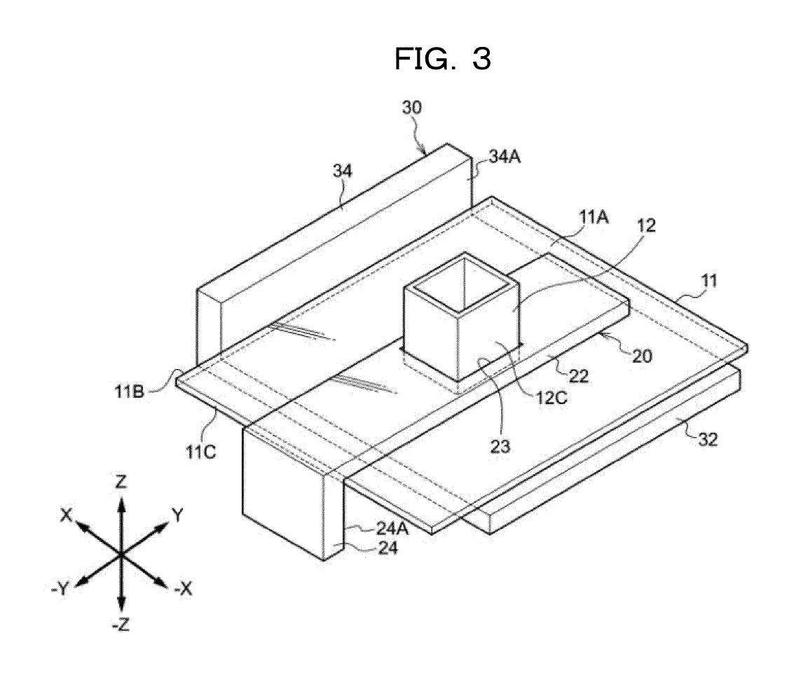

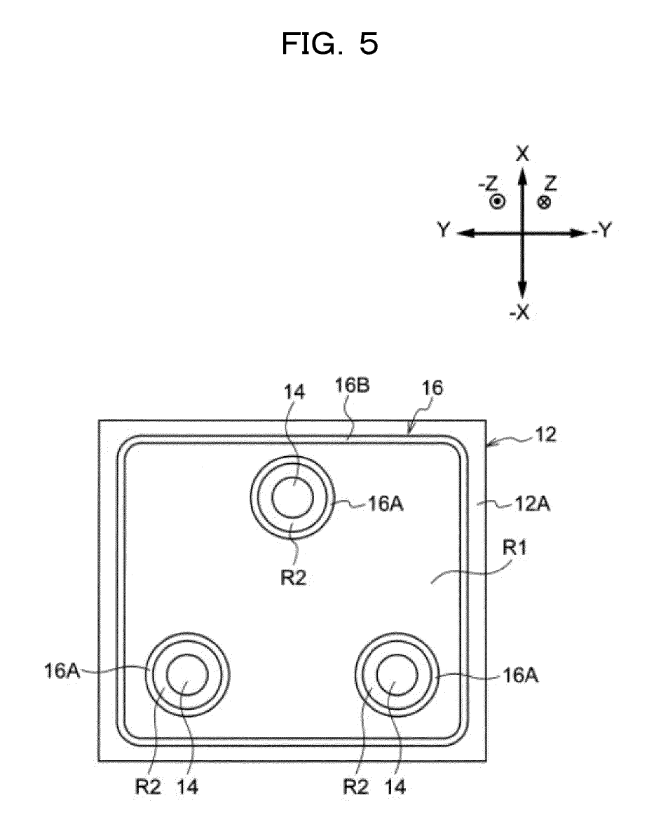

As depicted in FIG. 4, magnets 14 (an example of attracted bodies) that are attracted by the magnetic force of electromagnets 36 described hereafter are provided on the adhesion surface 12A side of the second component 12. As depicted in FIG. 5, for example, three magnets 14 are provided corresponding to the electromagnets 36 described hereafter. These magnets 14 are arranged so as to form a triangular shape in plan view. These three magnets 14 are arranged in the second component 12 so as to oppose each of the electromagnets 36 described hereafter when the second component 12 is located in the fixing position P of the first component 11 that has been positioned with respect to the first jig 30. It ought to be noted that FIG. 3 and FIG. 4 depict a state in which the second component 12 is located in the fixing position P of the first component 11 that has been positioned with respect to the first jig 30.

In addition, as depicted in FIG. 5, groove sections 16 (recessed sections) are formed in the adhesion surface 12A side of the second component 12. When seen in bottom view, the groove sections 16 include closed-curve (for example, circular) groove sections 16A that enclose each of the three magnets 14, and a closed-curve groove section 16B that encloses those three groove sections 16A. The regions enclosed by the groove sections 16A are adhering regions R2. Adhered regions S2 that oppose the adhering regions R2 in the adhesion surface 11A of the first component 11 are adhered with the adhering regions R2 by using the second adhesive 52. The region that is enclosed by the groove section 16B and does not include the adhering regions R2, in other words, the region demarcated by the groove sections 16A and the groove section 16B, is an adhering region R1. In this way, in the present embodiment, the adhering regions R2 and the adhering region R1 are separated by the groove sections 16A. An adhered region 51 that opposes the adhering region R1 in the adhesion surface 11A of the first component 11 is then adhered with the adhering region R1 by using the first adhesive 51.

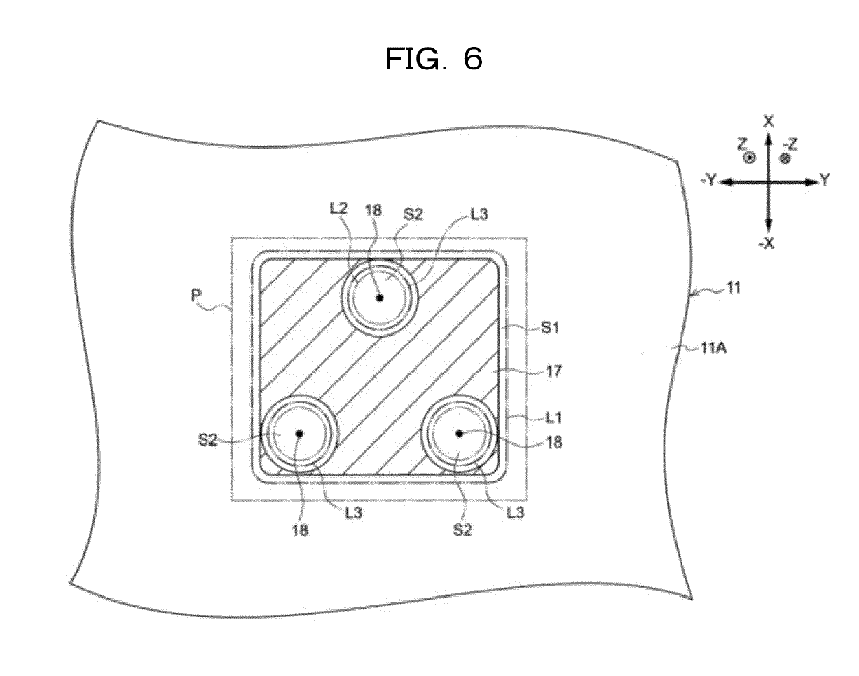

Furthermore, application marks that indicate application positions where the first adhesive 51 and the second adhesive 52 are to be applied may be affixed to at least one of the first component 11 and the second component 12. In the present embodiment, as depicted in FIG. 6, as an example, application marks 17 and 18 are affixed to the adhesion surface 11A of the first component 11. The application marks 18 that indicate the application positions of the second adhesive 52 are affixed inside the adhered regions S2 that are to be adhered with the adhering regions R2 of the second component 12. The application mark 17 (the broken line portion in FIG. 6) for the first adhesive 51 is affixed inside the adhered region S1 that is to be adhered with the adhering region R1 of the second component 12. It ought to be noted that the adhered regions S2 are the regions enclosed by the two-dot chain line L2 in FIG. 6. Furthermore, the adhered region S1 is the region enclosed by the two-dot chain line L1 and the two-dot chain line L3 in FIG. 6.

(First Jig 30)

As depicted in FIG. 1 to FIG. 3, the first jig 30 has a jig main body 32, a positioning section 34, and the electromagnets 36 as an example of a magnet. The jig main body 32 has a sheet shape that is thick in the Z direction (vertical direction). In addition, this jig main body 32 has a rectangular shape in plan view. The positioning section 34 is provided in a standing manner at the end section at the X direction side of the jig main body 32. Specifically, the positioning section 34 extends upward at a right angle to the jig main body 32. This positioning section 34 is formed in a sheet shape that is thick in the X direction, and is long in the Y direction.

In addition, the positioning section 34 has a reference surface 34A that faces the −X direction. This reference surface 34A positions the first component 11 in the X direction with respect to the jig main body 32 by coming into contact with an end surface 11B at the X-direction side in the first component 11. It ought to be noted that, as described hereafter, the first component 11 is positioned in the Y direction with respect to the jig main body 32 by a positioning section 24 of the second jig 20. In this way, in the present embodiment, the first component 11 is positioned with respect to the first jig 30, based on the external shape of the first component 11.

A plurality of the electromagnets 36 are arranged in the jig main body 32 so as to be located in the fixing position P of the first component 11 that has been positioned in the X direction and the Y direction with respect to the jig main body 32. Specifically, for example, three electromagnets 36 are arranged in the Z-direction front surface side of the jig main body 32 so as to oppose the magnets 14 of the second component 12. In other words, the magnets 36 are arranged so as to form a triangular shape in plan view. In the present embodiment, the attraction direction of the electromagnets 36 with respect to the magnets 14 is the −Z direction. In other words, the attraction direction of the electromagnets 36 with respect to the magnets 14 is the same direction as the adhesion direction of the second component 12 with respect to the first component 11.

In addition, the plurality of electromagnets 36 are arranged in such a way that the electromagnets 36 and the magnets 14 oppose each other in a one-to-one manner when the adhesion surface 12A of the second component 12 faces the adhesion surface 11A of the first component 11 at a predetermined angle of rotation about an axis that is orthogonal to the adhesion surface 11A. In other words, the three electromagnets 36 are arranged in such a way that the electromagnets 36 and the magnets 14 oppose each other only when a side surface 12C in the −X direction in FIG. 1 of the second component 12 faces the −X direction side. Consequently, for example, the electromagnets 36 and the magnets 14 do not oppose each other when the side surface 12C faces the X direction, the Y direction, or the −Y direction.

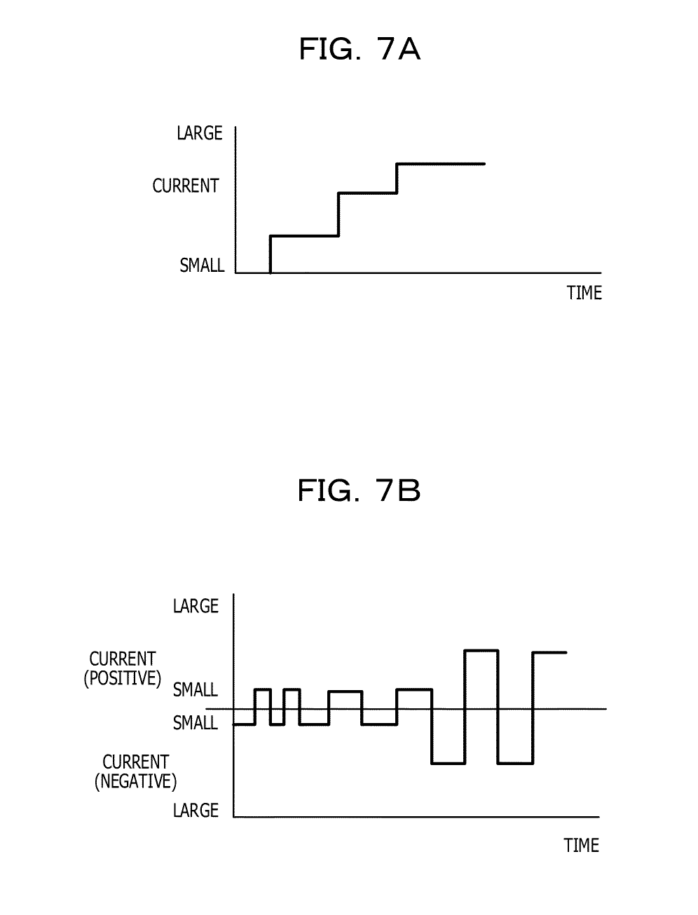

In addition, in the electromagnets 36, the strength of the magnetic force is controlled by controlling the magnitude of the current that is allowed to pass. For example, it is possible to increase the magnetic force in steps or gradually by increasing the magnitude of the current in steps or gradually as time elapses (see FIG. 7A). Furthermore, in the electromagnets 36, the polarity of the magnetic force is controlled by controlling the direction of the current that is allowed to pass. In addition, as depicted in FIG. 7B, in the electromagnets 36, it is possible for the magnetic force and the polarity to be switched at an arbitrary speed by controlling the frequency of the current (alternating current) that is allowed to pass. In this way, in the electromagnets 36, by altering the polarity, it is possible to cause an attraction force and a repulsion force to act with respect to the second component 12, and cause the second component 12 to vibrate. Furthermore, in the electromagnets 36, by altering the strength of the magnetic force, it is possible to alter the attraction force with respect to the second component 12, and cause the second component 12 to vibrate. In this way, in the electromagnets 36, by altering at least one of the strength and the polarity of the magnetic force thereof, it is possible to cause the second component 12 to vibrate and then to position the second component 12.

(Second Jig 20)

The second jig 20 is positioned in the Y direction in such a way as to be able to move in the X direction with respect to the first jig 30. Specifically, as depicted in FIG. 1 to FIG. 3, this second jig 20 has a jig main body 22 and the positioning section 24.

The jig main body 22 has a sheet shape that is thick in the Z direction (vertical direction). In addition, this jig main body 22 has a rectangular shape in plan view.

The positioning section 24 is provided at the end section at the −Y direction side of the jig main body 22 so as to extend in the −Z direction (downward) from the jig main body 22. This positioning section 24 is formed in a sheet shape that is thick in the Y direction.

In addition, the positioning section 34 has a reference surface 24A that faces the Y direction. This reference surface 24A positions the first component 11 in the −Y direction with respect to the jig main body 22 by coming into contact with an end surface 11C at the −Y direction side of the first component 11. In addition, the second jig 20 is positioned in the Y direction with respect to the first jig 30, and the first component 11 is thereby positioned in the Y direction also with respect to the jig main body 32 of the first jig 30.

A through hole 23 that passes through in the thickness direction of the jig main body 22 is formed in the jig main body 22. The through hole 23 has a rectangular shape that is larger than the plan-view external shape of the second component 12. The second component 12 is inserted into this through hole 23.

In addition, the second jig 20 has a holding mechanism (not depicted) that holds the second component 12 inserted into the through hole 23, spaced apart from the front surface of the first component 11 positioned in the first jig 30. This holding mechanism releases the holding of the second component 12 when the second component 12 that has been inserted into the through hole 23 has moved to the fixing position P of the first component 11, and causes the second component 12 to be lowered onto the first component 11. The second component 12 that has been inserted into the through hole 23 is thereby approximately positioned with respect to the fixing position P of the first component 11. In other words, the second component 12 is positioned with respect to the fixing position P of the first component 11 as the step prior to positioning using the magnetic force of the electromagnets 36.

It ought to be noted that the second component 12 may be inserted into the through hole 23 after the through hole 23 has moved onto the fixing position P of the first component 11. In this case, the aforementioned holding mechanism does not have to be employed.

(Component Assembly Manufacturing Method)

A method for manufacturing a component assembly obtained by the first component 11 and the second component 12 being fixed will now be described. The present manufacturing method, for example, is carried out using the aforementioned manufacturing apparatus 10.

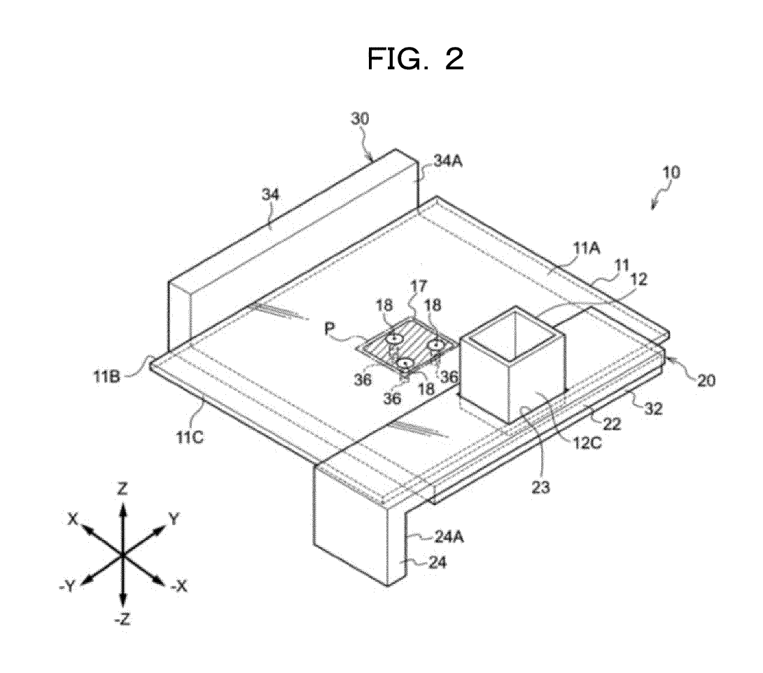

In the present manufacturing method, first, as depicted in FIG. 2, the first component 11 is positioned with respect to the first jig 30 in such a way that the fixing position P on the first component 11 is located above the electromagnets 36 in the first jig 30 (first positioning process). Specifically, the first positioning process is carried out as follows. In other words, the end surface 11B at the X direction side of the first component 11 is brought into contact with the reference surface 34A of the first jig 30, and the first component 11 is thereby positioned in the X direction with respect to the jig main body 32 of the first jig 30. In addition, the end surface 11C at the −Y direction side in the first component 11 is brought into contact with the reference surface 24A of the positioning section 24 of the second jig 20, and the first component 11 is thereby positioned in the −Y direction with respect to the jig main body 32 of the first jig 30. It ought to be noted that, for example, the electrification of the electromagnets 36 is halted in the first positioning process.

Next, the first adhesive 51 and the second adhesive 52 are applied to the adhesion surface 11A of the first component 11 (application process, see FIG. 4). Specifically, for example, a worker applies the first adhesive 51 and the second adhesive 52 to the adhesion surface 11A of the first component 11 by hand based on the application marks 17 and 18 on the first component 11. By applying the first adhesive 51 to the application mark 17 on the first component 11, the first adhesive 51 is applied in the adhered region 51 that is to be adhered with the adhering region R1 of the adhesion surface 11A of the first component 11. By applying the second adhesive 52 to the application marks 18 on the first component 11, the second adhesive 52 is applied in the adhered regions S2 that are to be adhered with the adhering regions R2 of the adhesion surface 11A of the first component 11.

It ought to be noted that the application process may be carried out at the same time as the first positioning process or prior to the first positioning process.

Next, the second component 12 is inserted into the through hole 23. At such time, the second component 12 is inserted into the through hole 23 in such a way that the side surface 12C of the second component 12 faces the −X direction side. It ought to be noted that the aforementioned application process may be carried out after the second component 12 has been inserted into the through hole 23.

Next, the second jig 20 is moved in the X direction with respect to the first jig 30 in such a way that the second component 12 is positioned in the fixing position P. Next, in the fixing position P, the holding of the second component 12 that is held in the through hole 23 is released, and the second component 12 is lowered onto the first component 11. The second component 12 is thereby approximately positioned with respect to the fixing position P of the first component 11.

Next, the second component 12 is attracted by the magnetic force of the electromagnets 36, and the second component 12 is positioned with respect to the first component 11 (second positioning process). In the second positioning process, as an example, by altering at least one of the strength and the polarity of the magnetic force of the electromagnets 36, the second component 12 is made to vibrate and is then positioned. In addition, this positioning is carried out in a state in which the uncured first adhesive 51 and second adhesive 52 are arranged between the adhesion surface 11A of the first component 11 and the adhesion surface 12A of the second component 12.

Next, the first adhesive 51 and the second adhesive 52 are cured and the first component 11 and the second component 12 are fixed (fixing process). In the fixing process, first, the second adhesive 52 is used to temporarily fix the first component 11 and the second component 12 (temporary fixing process). In this temporary fixing process, the magnetic force of the electromagnets 36 is increased, the second component 12 is made to move toward the first component 11, and the second adhesive 52 is formed into a thin layer to thereby induce the curing of the second adhesive 52. Next, after the electrification of the electromagnets 36 has been halted, the first component 11 and the second component 12 are removed from the first jig 30 and the second jig 20 (removal process). Next, by curing the first component 11 and the second component 12 for a specific period of time, the first component 11 and the second component 12 are permanently fixed using the first adhesive 51 (permanent fixing process). In this way, the fixing process includes the temporary fixing process, the removal process, and the permanent fixing process.

According to the above, a component assembly 13 is obtained in which the second component 12 is fixed at the predetermined fixing position P in the first component 11. It ought to be noted that it is desirable for the component assembly 13 to have at least two components. Furthermore, the component assembly 13 may have three or more components.

(Action and Effect of the Present Embodiment)

The action and the effect of the present embodiment will now be described.

In the present embodiment, as previously described, in the second positioning process, the second component 12 is attracted by the magnetic force of the electromagnets 36, and the second component 12 is positioned with respect to the first component 11. In other words, the second component 12 is positioned with respect to the first component 11, based on the position of the electromagnets 36.

Therefore, positioning marks, protrusions, and holes and so forth for positioning the second component 12 with respect to the first component 11 do not have to be provided in the first component 11 and the second component 12. Therefore, the first component 11 and the second component 12 have excellent designability and processability. This is particularly effective when a transparent member is used as the first component 11 in that there is no effect on designability. Furthermore, due to the freedom with regard to design constraints and so forth, it is possible to position and fix components even in the case of components and so forth in which it is difficult to provide positioning marks, protrusions, and holes and so forth (for example, display devices such as touch panels).

Furthermore, in the present embodiment, as previously described, in the second positioning process, the second component 12 is positioned with respect to the first component 11 in a state in which the uncured first adhesive 51 and second adhesive 52 are arranged between the adhesion surface 11A of the first component 11 and the adhesion surface 12A of the second component 12.

In this way, because the first adhesive 51 and the second adhesive 52 are not cured, it is easy for the second component 12 to be moved with respect to the first component 11 due to the viscosity and the surface tension of the first adhesive 51 and the second adhesive 52. Therefore, in accordance with the magnetic force of the electromagnets 36 acting on the second component 12, it is possible for the position of the second component 12 with respect to the first component 11 to be adjusted, and the second component 12 to be positioned with a high degree of precision with respect to the first component 11. Furthermore, fine positional adjustments are able to be carried out even from a state in which the second component 12 has been temporarily positioned with respect to the first component 11.

Furthermore, in the present embodiment, because the electromagnets 36 are used, it is possible for the strength and the polarity of the magnetic force that acts on the second component 12 to be controlled. Furthermore, because it is possible to stop the magnetic force from acting by halting the electrification of the electromagnets 36, it is easy to remove the first component 11 and the second component 12 from the first jig 30 and the second jig 20 after the temporary fixing process.

In addition, in the present embodiment, the second component 12 is made to vibrate and is then positioned by altering at least one of the strength and the polarity of the magnetic force of the electromagnets 36. Therefore, the magnets 14 of the second component 12 are moved to opposing positions that oppose the electromagnets 36, even if the magnets 14 have deviated from the opposing positions. It is thereby possible for the second component 12 to be positioned with a high degree of precision with respect to the first component 11.

Furthermore, in the present embodiment, in the fixing process, after the second component 12 has been temporarily fixed to the first component 11, the second component 12 is permanently fixed to the first component 11. In this way, because the second component 12 is temporarily fixed to the first component 11, in the permanent fixing process, the state in which the second component 12 is positioned with respect to the first component 11 by using the magnetic force does not have to be maintained. In other words, it is possible for the first component 11 and the second component 12 to be permanently fixed after they have been removed from the first jig 30 and the second jig 20. It is thereby possible for the first jig 30 and the second jig 20 to be used for other components to be fixed thereafter. In other words, it is possible for the number of the first jigs 30 and the second jigs 20 to be reduced in the production line.

Furthermore, in the present embodiment, the first adhesive 51 is applied to the adhered region 51 that is to be adhered with the adhering region R1, and the second adhesive 52 is applied in the adhered regions S2 that are to be adhered with the adhering regions R2 separated from the adhering region R1 by the groove sections 16A. Therefore, when the first component 11 and the second component 12 are adhered using the first adhesive 51 and the second adhesive 52, the first adhesive 51 and the second adhesive 52 do not flow out due to the groove sections 16A, and the mixing thereof is therefore suppressed. In addition, the flowing of the second adhesive 52 out toward an outside surface 12B of the second component 12 (see FIG. 4) is suppressed by the groove section 16B.

Furthermore, in the present embodiment, in the temporary fixing process, the magnetic force of the electromagnets 36 is increased, the second component 12 is made to move toward the first component 11, and the second adhesive 52 is formed into a thin layer. The curing of the second adhesive 52 is thereby induced. In this way, because the second adhesive 52 is caused to cure using the electromagnets 36, it is possible to reduce the number of components compared to when members other than the electromagnets 36 are used to bring about the curing of the second adhesive 52.

Furthermore, in the present embodiment, the plurality of electromagnets 36 are arranged in such a way that the electromagnets 36 and the magnets 14 oppose each other only when the side surface 12C of the second component 12 faces the −X direction side. Therefore, by arranging the second component 12 with respect to the first component 11 in such a way that the electromagnets 36 and the magnets 14 oppose each other, mistakes in the direction of the second component 12 with respect to the first component 11 are suppressed.

In addition, because the magnets 14 and the electromagnets 36 are arranged so as to form triangular shapes, it is possible for the direction of the second component 12 with respect to the first component 11 to be set to one direction with a small number of magnets.

### First Modified Example

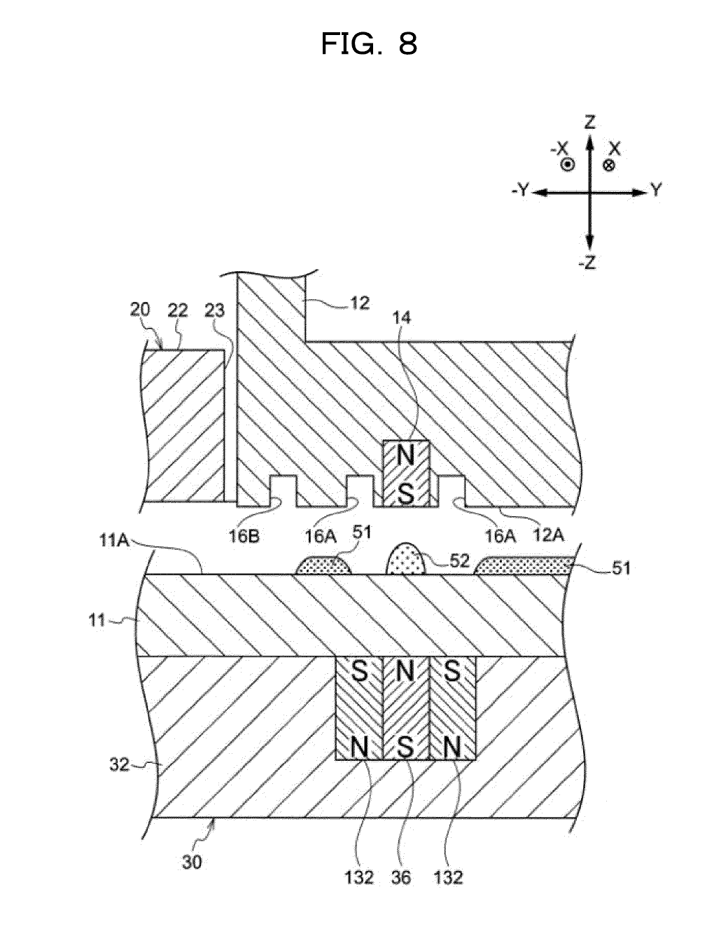

As depicted in FIG. 8, a magnet 132 having the same polarity as the magnets 14 may be provided around an electromagnet 36. The magnet 132 is cylindrical, for example. The electromagnet 36 is arranged in the hollow portion of the magnet 132.

According to the first modified example, due to the repulsion force produced by the magnet 132 that acts on the magnet 14 and the attraction force produced by the electromagnet 36, the second component 12 floats with respect to the first component 11, and the second component 12 is easy to move. It is therefore possible for the second component 12 to be positioned with a high degree of precision with respect to the first component 11. It ought to be noted that the magnet 132 may be an electromagnet, and may be a permanent magnet.

### Second Modified Example

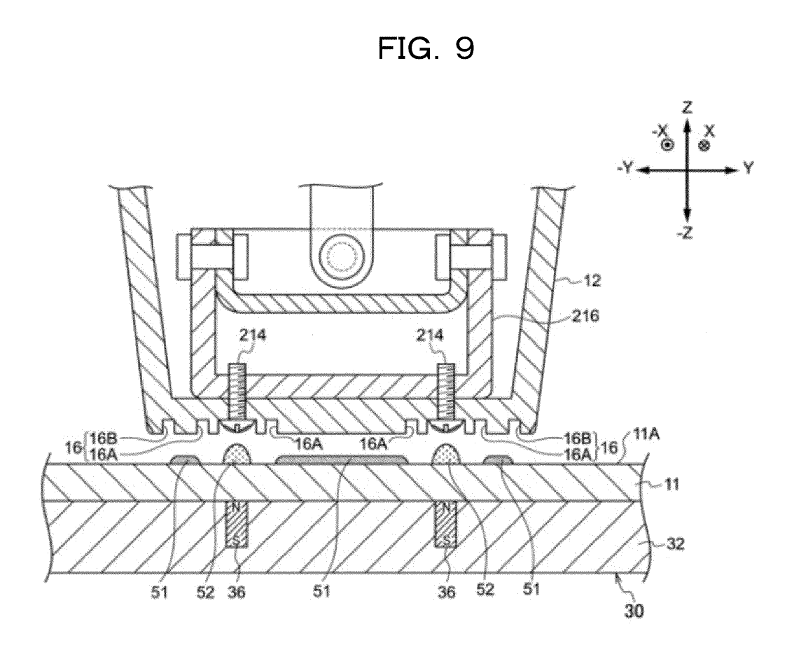

In the aforementioned embodiment, the magnets 14 are used as attracted bodies that are attracted by the magnetic force of the electromagnets 36; however, the configuration is not restricted to this. As depicted in FIG. 9, the attracted bodies may be metal components 214 provided in the second component 12. In other words, it is sufficient as long as the attracted bodies are attracted by the magnetic force of the electromagnets 36. Fastening members such as bolts and nuts are used as the metal components 214. It ought to be noted that the metal components 214 depicted in FIG. 9, are, specifically, bolts for fixing a fixed member such as a hinge 216 to the second component 12, for example.

According to the second modified example, because bolts or nuts or the like inside the second component 12 are used, a magnet does not have to be separately provided, and the number of components decreases.

### Third Modified Example

In the present embodiment, the uncured first adhesive 51 and second adhesive 52 are arranged between the adhesion surface 11A of the first component 11 and the adhesion surface 12A of the second component 12 when the second component 12 is positioned with respect to the first component 11. In addition to the uncured first adhesive 51 and second adhesive 52, for example, reduction members that reduce the friction between the first component 11 and the second component 12 may be arranged between the adhesion surface 11A of the first component 11 and the adhesion surface 12A of the second component 12.

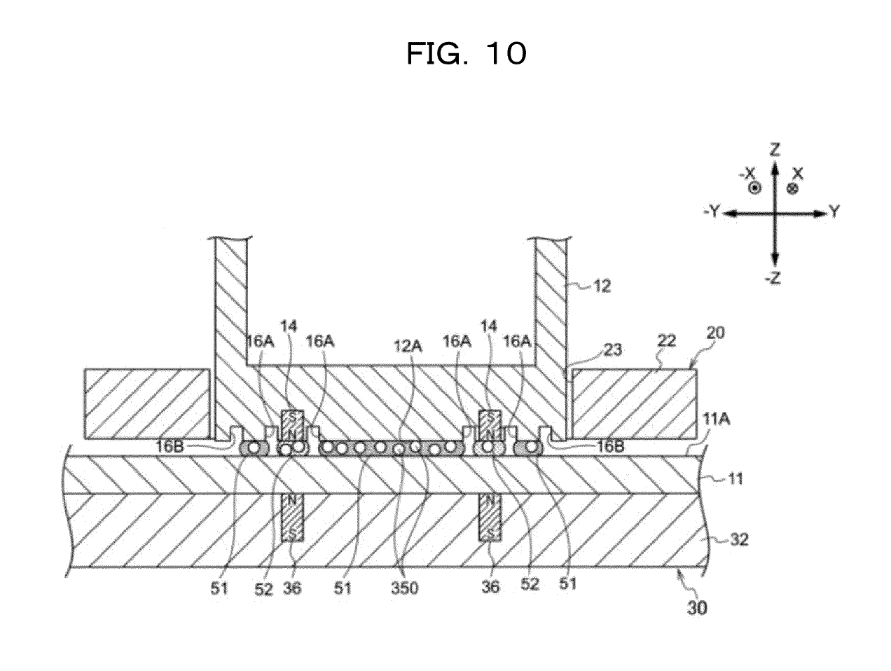

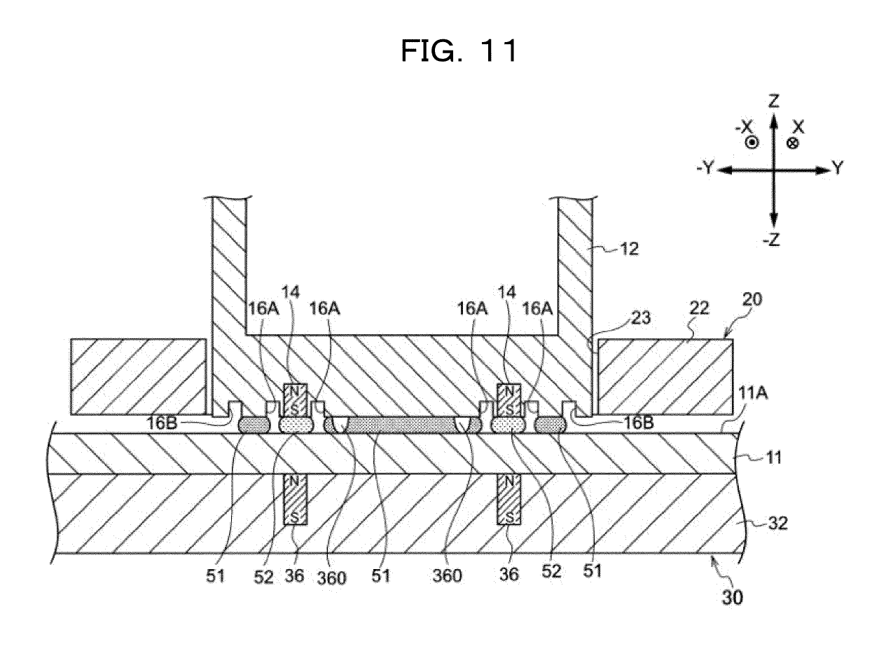

As depicted in FIG. 10, for example, spherical microbeads 350 are used as the reduction members. In addition, as depicted in FIG. 11, the reduction members may be protrusions 360 that are formed in at least one of the adhesion surface 12A of the second component 12 and the adhesion surface 11A of the first component 11. The tip end sections of the protrusions 360 are hemispherical, for example. Furthermore, surface processing to reduce friction may be carried out on the front surfaces of the protrusions 360.

According to the third modified example, it is easy for the second component 12 to be moved with respect to the first component 11 due to the reduction members that reduce friction between the first component 11 and the second component 12. Therefore, it is easy for the position of the second component 12 with respect to the first component 11 to be finely adjusted, and it is possible to position the second component 12 with a high degree of precision with respect to the first component 11. Furthermore, according to the third modified example, the thicknesses of the first adhesive 51 and the second adhesive 52 are also regulated by the reduction members.

### Fourth Modified Example

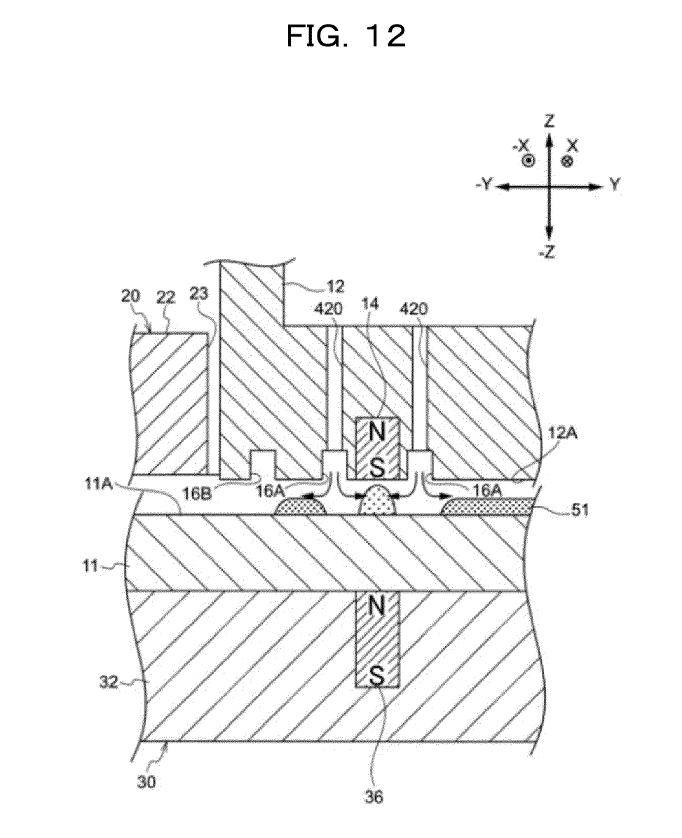

Air feed holes 420 that feed air between the adhesion surface 11A of the first component 11 and the adhesion surface 12A of the second component 12 may be formed in at least one of the first component 11 and the second component 12 (see FIG. 12). If the air feed holes 420 are formed in the second component 12, it is desirable for the air-feed direction of the air feed holes 420 to be set in such a way that air is blown toward the adhesion surface 11A of the first component 11. Furthermore, if the air feed holes 420 are formed in the first component 11, it is desirable for the air-feed direction of the air feed holes 420 to be set in such a way that air is blown toward the adhesion surface 12A of the second component 12. It is thereby easy for a force that causes the second component 12 to float with respect to the first component 11 to act. In the example depicted in FIG. 12, the air feed holes 420 are formed around magnets 14 in the second component 12.

In the fourth modified example, air is fed through the air feed holes 420 to between the adhesion surface 11A of the first component 11 and the adhesion surface 12A of the second component 12, and the second component 12 is thereby made to float with respect to the first component 11. It is thereby possible for the second component 12 to be positioned with respect to the first component 11 in a state in which the friction between the second component 12 and the first component 11 is low. It is therefore easy for the position of the second component 12 with respect to the first component 11 to be adjusted, and it is possible to position the second component 12 with a high degree of precision with respect to the first component 11.

### Fifth Modified Example

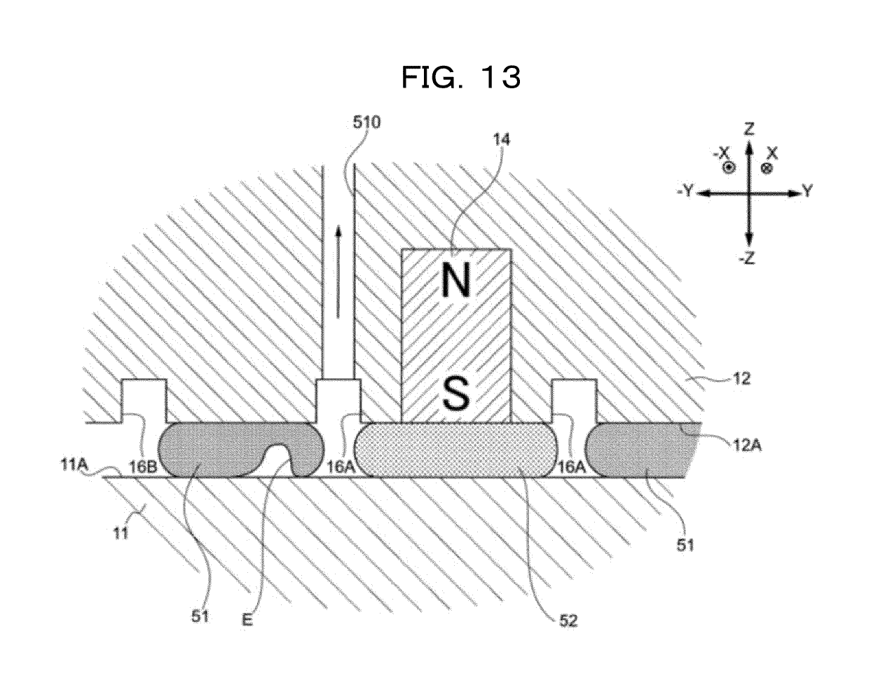

As depicted in FIG. 13, an air discharge hole 510 for discharging air E that has been incorporated by at least one of the second adhesive 52 and the first adhesive 51 may be formed in the second component 12.

In the fifth modified example, for example, when air E that has been incorporated by the second adhesive 52 is pushed out from the second adhesive 52, the air E is discharged through the air discharge hole 510. Therefore, the second adhesive 52 is suppressed from being discharged toward the outside surface 12B as the air E is discharged between the adhesion surface 11A of the first component 11 and the adhesion surface 12A of the second component 12 toward the outside surface 12B of the second component 12 (see FIG. 4).

### Other Modified Examples

In the present embodiment, two types of adhesives having different curing times are used; however, three or more types of adhesives having different curing types may be used. Furthermore, for the adhesives, one type of adhesive may be used.

Furthermore, in the present embodiment, the first adhesive 51 and the second adhesive 52 are applied to the adhesion surface 11A of the first component 11; however, the configuration is not restricted to this. For example, the first adhesive 51 and the second adhesive 52 may be applied to the adhesion surface 12A of second component 12, or may be applied to both the adhesion surface 11A of the first component 11 and the adhesion surface 12A of the second component 12.

Furthermore, in the present embodiment, the electromagnets 36 are used; however, permanent magnets may be used as the magnets. It ought to be noted that even in the case of a permanent magnet, it is possible for the strength of the magnetic force to be altered by displacing the permanent magnet with respect to the second component 12.

Furthermore, in the present embodiment, the groove sections 16 are formed in the adhesion surface 12A of the second component 12; however, the configuration is not restricted to this. For example, the groove sections 16 may be formed in the adhesion surface 11A of the first component 11, or may be formed in both the adhesion surface 11A of the first component 11 and the adhesion surface 12A of the second component 12.

Furthermore, in the present embodiment, in the permanent fixing process, the first component 11 and the second component 12 are permanently fixed while removed from the first jig 30 and the second jig 20; however, the first component 11 and the second component 12 may be permanently fixed in a state in which a magnetic force is made to act on the second component 12. According to this configuration, it is possible for curing to be carried out in a short period of time in the case where an adhesive that cures due to the application of pressure is used as the second adhesive 52.

Furthermore, in the present embodiment, the magnets 14 and the electromagnets 36 are arranged so as to form triangular shapes; however, the configuration is not restricted to this. For example, the magnets 14 and the electromagnets 36 may be arranged so as to form a polygon having four sides or more.

Furthermore, in the present embodiment, the first component 11 is positioned in the Y direction with respect to the jig main body 32 of the first jig 30 by the positioning section 24 of the second jig 20; however, the configuration is not restricted to this. For example, the first jig 30 may have a positioning section that positions the first component 11 in the Y direction with respect to the jig main body 32.

Furthermore, in the present embodiment, the second component 12 is inserted into the through hole 23 of the second jig 20, and the second component 12 is thereby approximately positioned with respect to the fixing position P of the first component 11; however, the configuration is not restricted to this. For example, the second component 12 may be placed at the fixing position P of the first component 11, based on the application mark 17 for the first adhesive 51.

Furthermore, the aforementioned plurality of modified examples may be combined and implemented as appropriate.

An embodiment of the technology disclosed in the present application has been described above; however, the technology disclosed in the present application is not restricted to the aforementioned, and it goes without saying that it is possible for various modifications to be implemented aside from those mentioned above without departing from the purpose thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A component assembly manufacturing method comprising:
positioning a first component to a jig;
applying an adhesive to at least one of an adhesion surface of the first component and an adhesion surface of a second component;
positioning the second component to the first component by a magnetic force that acts between the second component and the jig, in a state in which the adhesive in an uncured state is arranged between the adhesion surface of the first component and the adhesion surface of the second component; and
fixing the first component and the second component by the adhesive.

2. The component assembly manufacturing method according to claim 1,
wherein two or more types of adhesives includes different curing times are applied in the applying, and
in the fixing, from among the two or more types of adhesives, a second adhesive includes a shorter curing time than a first adhesive is used to temporarily fix the first component and the second component, and the first adhesive is used to permanently fix the first component and the second component.

3. The component assembly manufacturing method according to claim 2,
wherein, in the applying,
the first adhesive is applied to one of two adhering regions separated by a groove section formed in at least one of an adhesion surface of the first component and an adhesion surface of the second component, or to an adhered region that is to be adhered with that adhering region, and
the second adhesive is applied to the other of the two adhering regions separated by the groove section, or an adhered region that is to be adhered with that adhering region.

4. The component assembly manufacturing method according to claim 2,
wherein, in the fixing, the magnetic force is increased to cause the second component to move toward the first component, and the second adhesive is formed into a thin layer.

5. The component assembly manufacturing method according to claim 1,
wherein, in the positioning the second component, by altering at least one of a strength and a polarity of the magnetic force, the second component is made to vibrate and is then positioned.

6. The component assembly manufacturing method according to claim 1,
wherein, in the positioning the second component, the second component is positioned with respect to the first component in a state in which a reduction member that reduces friction between the first component and the second component is arranged, together with the uncured adhesive, between the adhesion surface of the first component and the adhesion surface of the second component.

7. The component assembly manufacturing method according to claim 1,
wherein, in the positioning the second component, the second component is positioned with respect to the first component in a state in which air is being fed between the adhesion surface of the first component and the adhesion surface of the second component, through an air feed hole formed in at least one of the first component and the second component.

8. The component assembly manufacturing method according to claim 1,
wherein an air discharge hole that is able to discharge air that has been incorporated by the adhesive is formed in at least one of the first component and the second component.

9. The component assembly manufacturing method according to claim 1,
wherein three or more of either magnets that cause the magnetic force to act, or attracted bodies that are attracted by the magnetic force of the magnet, are provided in the second component,
a same quantity of the other of the magnets or the attracted bodies is provided in the jig, and
the jig is used with the other of the magnets or the attracted bodies being arranged therein in such a way that the magnets and the attracted bodies oppose each other in a one-to-one manner when the adhesion surface of the second component faces the adhesion surface of the first component at a predetermined angle of rotation about an axis that is orthogonal to the adhesion surfaces.

10. A positioning apparatus comprising:
a positioning section that positions a first component with respect to a jig main body; and
magnets that are provided in the jig main body, and, in a state in which an uncured adhesive is arranged between an adhesion surface of the first component and an adhesion surface of a second component, attract the second component with a magnetic force, and position the second component with respect to the first component.

11. The positioning apparatus according to claim 10,
wherein the magnets, by altering at least one of a strength and a polarity of the magnetic force, cause the second component to vibrate and then position the second component.

12. The positioning apparatus according to claim 10,
wherein the magnets increase the magnetic force and cause the second component to move toward the first component, forming the adhesive into a thin layer.

13. The positioning apparatus according to claim 10,
wherein the magnets position the second component with respect to the first component in a state in which air is fed between the adhesion surface of the first component and the adhesion surface of the second component, through an air feed hole formed in at least one of the first component and the second component.

14. The positioning apparatus according to claim 10,
wherein the magnets are provided in a same quantity as attracted bodies of which there are three or more provided in the second component, and those attracted bodies are attracted by the magnetic force, and
the magnets are arranged in such a way that the magnets and the attracted bodies oppose each other in a one-to-one manner when the adhesion surface of the second component faces the adhesion surface of the first component at a predetermined angle of rotation about an axis that is orthogonal to the adhesion surfaces.

15. The positioning apparatus according to claim 10, further comprising:
an air feed hole that is formed in at least one of the first component and the second component, and is able to feed air between the adhesion surface of the first component and the adhesion surface of the second component.

16. The positioning apparatus according to claim 10, further comprising:
an air discharge hole that is formed in at least one of the first component and the second component, and is able to discharge air that has been incorporated by the adhesive.

17. The positioning apparatus according to claim 10, further comprising:
a magnet that is arranged around each of the magnets, and causes a magnetic force having the reverse polarity of the magnets to act on the second component.

18. A component assembly comprising:
a first component;
a second component that is fixed to the first component by two or more types of adhesives having different curing times; and
an attracted body that is arranged toward a surface that adheres with the first component in the second component, and is attracted by a magnet.

19. The component assembly according to claim 18,
wherein a first adhesive and a second adhesive are included in the two of more types of adhesives,
one of two adhering regions separated by a groove section formed in at least one of an adhesion surface of the first component and an adhesion surface of the second component, and an adhered region opposing that adhering region are adhered using the first adhesive, and
the other of the two adhering regions separated by the groove section, and an adhered region opposing that adhering region are adhered using the second adhesive.

20. The component assembly according to claim 18, comprising:
a mark affixed inside the one adhering region or the adhered region therefor; and
a mark affixed inside the other adhering region or the adhered region therefor.
